(19) United States
(12) Patent Application Publication
(10) Pub. No.: US 2008/0270866 A1
(43) Pub. Date: Oct. 30, 2008

(54) TRANSMISSION WITH AUTOMATIC REPEAT REQUEST PROCESS

(75) Inventors: Hyung-Nam Choi, Hamburg (DE); Michael Eckert, Braunschweig (DE); Christian Drewes, Germering (DE); Manfred Zimmermann, Sauerlach (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/740,645

(22) Filed: Apr. 26, 2007

(51) Int. Cl. G06F 15/16

(52) U.S. Cl. 714/748

(57) ABSTRACT

Method for transmitting data includes selecting an automatic repeat request process from a plurality of automatic repeat request processes, the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed. The data are transmitted using the selected automatic repeat request process.

### BACKGROUND

Embodiments of the present invention relate generally to a method for transmitting data, a data transmission device and a computer program product.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication system based on an exemplary embodiment of the invention;

FIG. 2 shows an illustration of a protocol structure for the UMTS air interface in accordance with an embodiment of the invention;

FIG. 3 shows the patterns of transmission time gaps in accordance with an embodiment of the invention;

FIG. 4 shows four sub-channels of an “N-Channel Stop-and-Wait” process in accordance with an embodiment of the invention;

FIG. 5 shows the operation of the HARQ method for each sub-channel in accordance with an embodiment of the invention;

FIG. 6 shows a data transmission device in accordance with an embodiment of the invention;

FIG. 7 shows a data transmission device in accordance with another embodiment of the invention;

FIG. 8 shows an uplink data transmission scenario in accordance with an embodiment of the invention;

FIG. 9 shows an uplink data transmission scheme in accordance with an embodiment of the invention; and

FIG. 10 shows a flow diagram illustrating a method for transmitting data in accordance with an embodiment of the invention.

### DESCRIPTION

In order to improve the transmission of data in the downlink direction (transmission direction from the base station NodeB to the mobile radio terminal device, also referred to as User Equipment (UE)), inter alia, the error correction method hybrid automatic repeat request (HARQ) has been introduced into the physical protocol layer (PHY) and into the medium access control protocol layer (MAC) in the Universal Mobile Telecommunications System (UMTS) Release 5. The hybrid method HARQ is based on the combination of channel coding in the physical protocol layer and an automatic repeat request mechanism in the medium access control protocol layer. In accordance with the HARQ, in case that transmission errors occur in the transmission of data, the data, e.g. a data packet, that has been received with errors from the receiver, the transmitted data is repeatedly sent by the transmitter, wherein the repeated transmission uses another channel coding redundancy to protect the transmitted data. The receiver then combines the erroneous received initial data, e.g. the initial data packet, with the re-transmitted data, e.g. re-transmitted data packets. In the best case scenario, the thus combined data (e.g. the thus combined data packet) is decoded as error-free. If this is not the case, the data, e.g. the data packet will be transmitted again, e.g. again using a different channel coding redundancy to protect the transmitted data.

For providing the channel coding redundancy, different mechanisms may be used such as e.g. a convolutional code. A convolutional code is a code in which each m-bit information to be encoded is transformed into a n-bit coded stream with n≧m and the (n−m)-bits representing the coding redundancy. Convolutional codes can be implemented by shift registers. It should be mentioned that any other suitable mechanism to provide channel coding redundancy may be used in an alternative embodiment of the invention.

In an embodiment of the invention, a so called asynchronous hybrid automatic repeat request method is provided for the downlink transmission direction. In the asynchronous hybrid automatic repeat request method, the re-transmission can be provided independently from the transmission time instant of the initial data transmission (which in one embodiment of the invention corresponds to the hybrid automatic repeat request process (HARQ process) used for the initial data transmission).

In order to improve the data transmission in the uplink direction (transmission direction from the mobile radio terminal device, also referred to as User Equipment (UE) to the base station NodeB, the hybrid automatic repeat request (HARQ) has also been introduced in the subsequent UMTS Release 6.

In one embodiment of the invention, a so called synchronous hybrid automatic repeat request method is provided for the uplink transmission direction. In the synchronous hybrid automatic repeat request method, the re-transmission can only be provided dependent from the transmission time instant of the initial data transmission (which in one embodiment of the invention corresponds to the hybrid automatic repeat request process (HARQ process) used for the initial data transmission). In an embodiment of the invention, this means that the re-transmission can be provided only in the same HARQ process that has been previously used for transmitting the initial data, in other words, only in the same HARQ process that has been previously used for the initial data transmission.

One technical aspect regarding the synchronous HARQ in the uplink direction which has not sufficiently been addressed so far is as follows:

In case of transmission time gaps in the uplink direction, which may usually be generated and used in UMTS for the measurement of cells on other frequencies (for example UMTS Frequency Division Duplex (FDD) cells or Global System for Mobile Communication (GSM) cells), one or a plurality of HARQ processes may not be used for the data transmission, in particular in the case where the duration of a transmission time gap is larger than the transmission time interval (TTI) used for transmitting data.

This may result in a delay of the transmission of re-transmissions, since the transmission time instants of these re-transmissions coincide with the transmission time gaps. This may be critical for data of data transmission services that have stringent quality requirements regarding transmission delays, e.g. for speech data transmission using the internet protocol Voice over Internet Protocol (VoIP).

Although the following embodiments of the invention describe mobile radio communication systems, it should be mentioned that alternative embodiments of the invention may be provided in a fixed line communication network. Any other kind of communication network for transmitting data may be used in an alternative embodiment of the invention.

Furthermore, the embodiments of the invention are not limited to the uplink transmission direction and may also be used in downlink transmission direction, if desired.

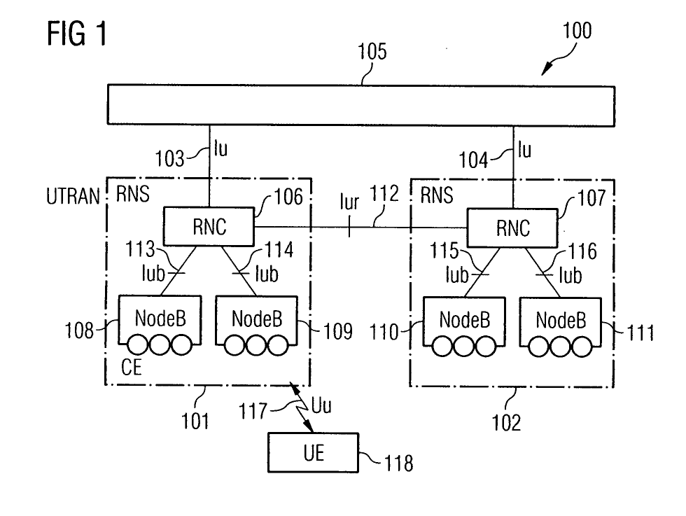

FIG. 1 shows a communication system based on an exemplary embodiment of the invention.

FIG. 1 shows a UMTS mobile radio system 100, for reasons of simpler illustration particularly the components of the UMTS mobile radio access network (UMTS Terrestrial Radio Access Network, UTRAN), which has a plurality of mobile radio network subsystems (RNS) 101, 102 which are respectively connected by means of an “Iu” interface 103, 104 to the UMTS core network (CN) 105. A mobile radio network subsystem 101, 102 has a respective mobile radio network control unit (Radio Network Controller, RNC) 106, 107 and also one or more UMTS base stations 108, 109, 110, 111, which are also called NodeB in UMTS.

Within the mobile radio access network, the mobile radio network control units 106, 107 of the individual mobile radio network subsystems 101, 102 are connected to one another by means of an “Iur” interface 112. Each mobile radio network control unit 106, 107 respectively monitors the assignment of mobile radio resources for all the mobile radio cells in a mobile radio network subsystem 101, 102.

A UMTS base station 108, 109, 110, 111 is respectively connected to a mobile radio network control unit 106, 107 associated with the base station by means of an “Iub” interface 113, 114, 115, 116.

Each UMTS base station 108, 109, 110, 111 clearly provides radio coverage for one or more mobile radio cells (CE) within a mobile radio network subsystem 101, 102. Between a respective UMTS base station 108, 109, 110, 111 and a subscriber terminal 118 (user equipment, UE), subsequently also called mobile radio terminal, in a mobile radio cell, message signals or data signals are transmitted using an air interface, called Uu air interface 117 in UMTS, preferably using a multiple access transmission method.

By way of example, the UMTS-FDD mode (Frequency Division Duplex) is used to achieve separate signal transmission in the uplink and downlink directions (Uplink: signal transmission from the mobile radio terminal 118 to the respective UMTS base station 108, 109, 110, 111; downlink: signal transmission from the respective associated UMTS base station 108, 109, 110, 111 to the mobile radio terminal 118) through appropriate separate assignment of frequencies or frequency ranges.

A plurality of subscribers, in other words a plurality of activated mobile radio terminals 118 registered in the mobile radio access network, in the same mobile radio cell preferably have their signal transmissions separated from one another using orthogonal codes, particularly using the “CDMA method” (Code Division Multiple Access).

In this connection, it should be noted that FIG. 1 shows only one mobile radio terminal 118 for reasons of simple illustration. In general, however any number of mobile radio terminals 118 are provided in the mobile radio system 100.

The communication between a mobile radio terminal 118 and another communication terminal can be set up using a complete mobile radio communication link to another mobile radio terminal, alternatively to a landline communication terminal.

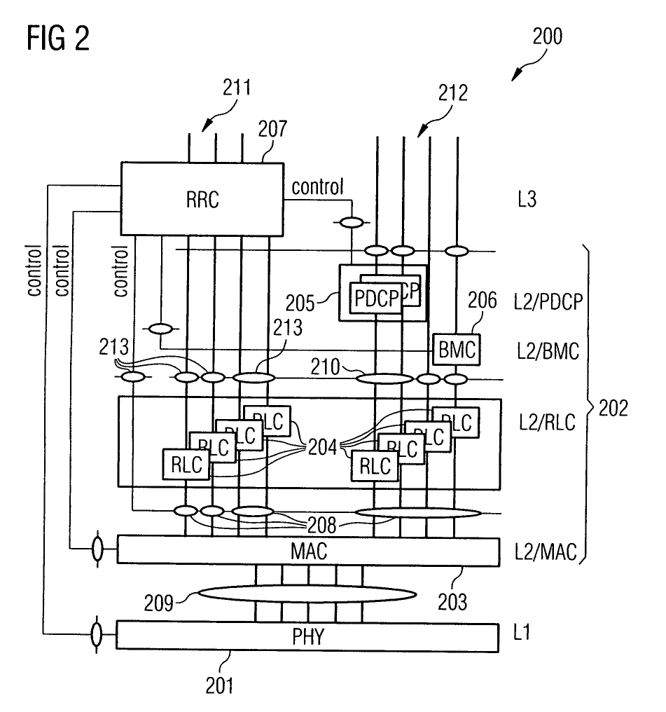

FIG. 2 shows an illustration of a protocol structure for the UMTS air interface in accordance with an embodiment of the invention.

As FIG. 2 shows, the UMTS air interface 117 is logically divided into three protocol layers (symbolized in FIG. 2 by a protocol layer arrangement 200). The units (entities) ensuring and providing the functionality of the respective protocol layers described below are implemented both in the mobile radio terminal 118 and in the UMTS base station 108, 109, 110, 111 or in the respective mobile radio network control unit 106, 107.

The bottommost layer shown in FIG. 2 is the physical layer PHY 201, which represents the protocol layer 1 on the basis of the OSI reference model (Open System Interconnection) defined by ISO (International Standardisation Organisation).

The protocol layer arranged above the physical layer 201 is the data link layer 202, protocol layer 2 on the basis of the OSI reference model, which for its part has a plurality of subprotocol layers, namely the Medium Access Control protocol Layer (MAC protocol layer) 203, the Radio Link Control protocol layer 204 (RLC protocol layer), the Packet Data Convergence Protocol protocol layer 205 (PDCP protocol layer), and also the Broadcast/Multicast Control protocol layer 206 (BMC protocol layer).

The topmost layer of the UMTS air interface Uu is the mobile radio network layer (protocol layer 3 on the basis of the OSI reference model), having the mobile radio resource control unit 207 (Radio Resource Control protocol layer, RRC protocol layer).

Each protocol layer 201, 202, 203, 204, 205, 206, 207 provides the protocol layer above it with its services via prescribed, defined service access points.

To provide a better understanding of the protocol layer architecture, the service access points have been provided with generally customary and unambiguous names, such as logical channels 208 between the MAC protocol layer 203 and the RLC protocol layer 204, transport channels 209 between the physical layer 201 and the MAC protocol layer 203, radio bearers (RB) 210 between the RLC protocol layer 204 and the PDCP protocol layer 205 or the BMC protocol layer 206, and also signalling radio bearers (SRB) 213 between the RLC protocol layer 204 and the RRC protocol layer 207.

On the basis of UMTS, the protocol structure 200 shown in FIG. 2 is split not just horizontally into the above-described protocol layers and units of the respective protocol layers, but also vertically into a “control protocol plane” 211 (Control plane, C plane), which contains parts of the physical layer 201, parts of the MAC protocol layer 203, parts of the RLC protocol layer 204 and also the RRC protocol layer 207, and the user protocol plane 212 (User plane, U plane), which contains parts of the physical layer 201, parts of the MAC protocol layer 203, parts of the RLC protocol layer 204, the PDCP protocol layer 205 and also the BMC protocol layer 206.

The units of the control protocol plane 211 are used to transmit exclusively control data, which are required for the establishment, release and also maintenance of a communication link, whereas the units of the user plane 212 are used to transmit the user data, e.g. data originating from a speech call.

Each protocol layer or each unit (entity) of a respective protocol layer has particular prescribed functions during mobile radio communication. The transmitter end needs the task of the physical layer 201 or of the units of the physical layer 201, to ensure the secure transmission via the air interface 117 of data coming from the MAC protocol layer 203. In this connection, the data are mapped onto physical channels (not shown in FIG. 2). The physical layer 201 provides the MAC protocol layer 203 with its services via transport channels 209 and these are used to stipulate how and with what characteristics the data are to be transmitted via the air interface 117. The fundamental functions which are provided by the units of the physical layer 201 include channel coding, modulation and CDMA code spreading. Correspondingly, the physical layer 201 or the entities of the physical layer 201 at the receiver end performs the CDMA code despreading, demodulation and the decoding of the received data and then forwards these data to the MAC protocol layer 203 for further processing.

The MAC protocol layer 203 or the units of the MAC protocol layer 203 provides or provide the RLC protocol layer 204 with its or their services using logical channels 208 as service access points and these are used to characterize what type of data are to be transmitted via the air interface. The task of the MAC protocol layer 203 in the transmitter, i.e. during data transmission in the uplink direction in the mobile radio terminal 118, is particularly to map the data which are present on a logical channel 208 above the MAC protocol layer 203 onto the transport channels 209 of the physical layer 201. The physical layer 201 provides the transport channels 209 with discrete transmission rates for this. It is therefore a function of the MAC protocol layer 203 or of the entities of the MAC protocol layer 203 in the mobile radio terminal 118 in the transmission situation to select a suitable transport format (TF) for each configured transport channel on the basis of the respective current data transmission rate and the respective data priority of the logical channels 208 which are mapped onto the respective transport channel 209, and also the available transmission power of the mobile radio terminal 118 (UE). A transport format contains, inter alia, a stipulation of how many MAC data packet units, called transport block, are transmitted, in other words transferred, to the physical layer 201 via the transport channel 209 per transmission period TTI (Transmission Time Interval). The allowed transport formats and also the allowed combinations of the transport formats for the various transport channels 209 are signalled to the mobile radio terminal 118 by the mobile radio network control unit 106, 107 when a communication link is set up. In the receiver, the units of the MAC protocol layer 203 split the transport blocks received on the transport channels 209 over the logical channels 208 again.

The MAC protocol layer or the units of the MAC protocol layer 203 normally has or have three logical units. The “MAC-d unit” (MAC dedicated unit) handles the user data and the control data, which are mapped onto the dedicated transport channels DCH (Dedicated Channel) via the corresponding dedicated logical channels DTCH (Dedicated Traffic Channel) and DCCH (Dedicated Control Channel). The MAC-c/sh unit (MAC control/shared unit) handles the user data and the control data from logical channels 208, which are mapped onto the common transport channels 209, such as the common transport channel RACH (Random Access Channel) in the uplink direction or the common transport channel FACH (Forward Access Channel) in the downlink direction. The MAC-b unit (MAC broadcast unit) handles only the mobile radio cell-related system information, which is mapped via the logical channel BCCH (Broadcast Control Channel) onto the transport channel BCH (Broadcast Channel) and is broadcast to all of the mobile radio terminals 118 in the respective mobile radio cell.

Using the RLC protocol layer 204 or using the units of the RLC protocol layer 204, the RRC protocol layer 207 is provided with its services by means of signalling radio bearers (SRB) 213 as service access points, and the PDCP protocol layer 205 and the BMC protocol layer 206 are provided with their services by means of radio bearers (RB) 210 as service access points. The signalling radio bearers and the radio bearers characterize the way in which the RLC protocol layer 204 needs to handle the data packets. To this end, by way of example, the RRC protocol layer 207 stipulates the transmission mode for each configured signalling radio bearer or radio bearer. The following transmission modes are provided in UMTS:
Transparent mode (TM);
Unacknowledged mode (UM); or
Acknowledged mode (AM).

The RLC protocol layer 204 is modelled such that there is an independent RLC entity for each radio bearer or signalling radio bearer. In addition, the task of the RLC protocol layer or of its entities 204 in the transmission device is to segment or assemble the user data and the control data from radio bearers or signalling radio bearers into data packets. The RLC protocol layer 204 transfers the data packets produced after the segmentation or the assembly to the MAC protocol layer 203 for further transport or for further processing.

The PDCP protocol layer 205 or the units of the PDCP protocol layer 205 is or are set up to transmit or to receive data from the “Packet Switched Domain” (PS domain). The main function of the PDCP protocol layer 205 is to compress or decompress the IP header information (Internet Protocol header information).

The BMC protocol layer 206 or its entities is or are used to transmit or to receive “cell broadcast messages” via the air interface.

The RRC protocol layer 207 or the entities of the RRC protocol layer 207 is or are responsible for the establishment, release and reconfiguration of physical channels, transport channels 209, logical channels 208, signalling radio bearers 213 and radio bearers 210 and also for the configuration of the parameters of the protocol layer 1, i.e. of the physical layer 201 and of the protocol layer 2. To this end, the RRC units, i.e. the units of the RRC protocol layer 207, in the mobile radio network control unit 106, 107 and the respective mobile radio terminal 118 exchange appropriate RRC messages, via the signalling radio bearers 213.

In embodiments of the invention, in order to carry out Inter-Frequency measurements on UMTS cells or in order to carry out Inter-RAT (Radio Access Technology) measurements on GSM cells, transmission time gaps are generated in a UMTS system based on the Code Division Multiple Access (CDMA) scheme using the so called “Compressed Mode” feature. Compressed Mode is a specific feature in the UMTS Frequency Division Duplex (FDD) mode for generating transmission time gaps in the uplink and in the downlink in the Radio Resource Control (RRC) protocol state CELL_DCH, in which the UE has been allocated dedicated mobile radio resources.

To do this, in an embodiment of the invention, the mobile radio network, e.g. the mobile radio access network, e.g. the UMTS Terrestrial Radio Access Network (UTRAN) configures the corresponding Compressed Mode parameters for the UE. In an embodiment of the invention, the Compressed Mode parameters include, inter alia, the length of the transmission time gap (also referred to as Transmission Gap Length, TGL), the distance between the start of two transmission time gaps (Transmission Gap start Distance, TGD) and the duration of the application of the transmission time gaps (Transmission Gap Pattern Length). In an alternative embodiment of the invention, additional Compressed Mode parameters may be provided for the UE.

As an example, the following table describes the configuration of uplink Compressed Mode parameters for Inter-Frequency measurements (e.g. measurements from UMTS FDD cells on other frequencies) as well as for Inter-RAT measurements (e.g. measurements from GSM cells):

Table of the Compressed Mode parameters for Inter-Frequency
measurements and for Inter-RAT measurements

| | Inter- | GSM | GSM Initial | GSM BSIC |
|---|---|---|---|---|
| | Frequency | Carrier | BSIC | re- |
| Parameter | FDD | RSSI | identification | confirmation |
| TGSN (Transmission Gap | 8 | 8 | 8 | 8 |
| Starting Slot Number) | | | | |
| TGL1 (Transmission Gap | 14 | 14 | 14 | 14 |
| Length 1) | | | | |
| TGL2 (Transmission Gap | 14 | 14 | 14 | 14 |
| Length 2) | | | | |
| TGD (Transmission Gap | 0 | 60 | 45 | 0 |
| Distance) | | | | |
| TGPL1 (Transmission Gap | 12 | 24 | 24 | 24 |
| Pattern Length) | | | | |
| TGPL2 (Transmission Gap | — | — | — | — |
| Pattern Length) | | | | |
| TGCFN (Transmission Gap | (Current | (Current | (Current | (Current |
| Connection Frame Number): | CFN + (238 − | CFN + (242 − | CFN + (256 − | CFN + (253 − |
| | TTI/10 msec)) | TTI/10 msec)) | TTI/10 msec)) | TTI/10 msec)) |
| | mod 256 | mod 256 | mod 256 | mod 256 |
| UL/DL compressed mode | DL, UL or DL | DL, UL or | DL, UL or DL | DL, UL or |
| selection | & UL | DL & UL | & UL | DL & UL |
| UL compressed mode | SF/2 | SF/2 | SF/2 | SF/2 |
| method | | | | |
| DL compressed mode | SF/2 | SF/2 | SF/2 | SF/2 |
| method | | | | |

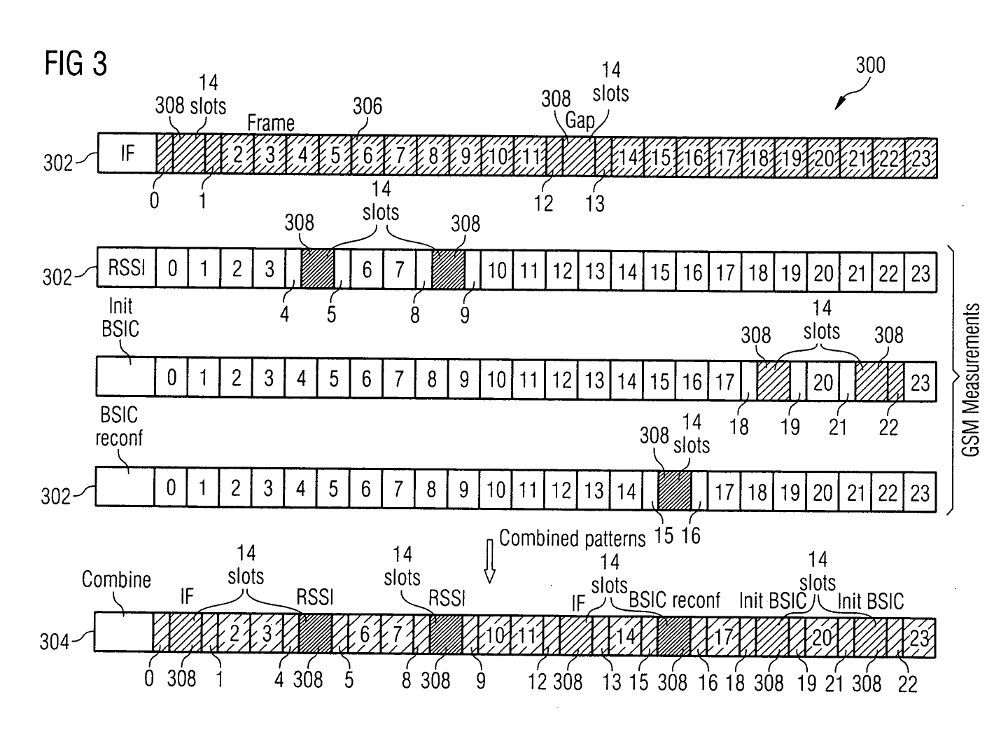

FIG. 3 shows the patterns of transmission time gaps in accordance with an embodiment of the invention in a transmission time gap diagram 300.

More specifically, FIG. 3 shows the patterns 302 of transmission time gaps for each individual measurement and the combined patterns 304 of the transmission time gaps within a transmission time period of 24 radio frames 306, each having a length of 10 ms (in FIG. 3 numbered from 0 to 23) in accordance with an embodiment of the invention. Each radio frames 306 of the length of 10 ms includes 15 time slots. The transmission time gaps are denoted in FIG. 3 with reference numeral 308. Each transmission time gap 308 of the transmission time gaps 308 include 14 time slots.

In a future UMTS system in accordance with an embodiment of the invention, which is also referred to as Long Term Evolution (LTE) UMTS system and which is based on the multiple access method Orthogonal Frequency Division Multiple Access in the downlink and on Single Carrier Frequency Division Multiple Access in the uplink, the transmission time gaps will be generated by means of NodeB scheduling.

As already mentioned above, hybrid automatic repeat request (HARQ) is an error correction method which is used to ensure that data (e.g. data packets) are successfully (in the sense of error-free) transmitted from a transmitter to the receiver. In an embodiment of the invention, the data transmission is carried out via a mobile radio channel, which may distort the information contained in the data (e.g. in the data packets) despite channel coding, due to the characteristics of the mobile radio channel. In one embodiment, the hybrid method HARQ is based on the combination of channel coding (e.g. using an error correction code) and an automatic repeat request (ARQ) mechanism, wherein in case of transmission errors, the initial data (e.g. the initial data packet), which have been received with errors, are repeated by the transmitter, however, using another channel coding redundancy. The received initial erroneous data (e.g. initial erroneous data packet) is then combined and decoded with the re-transmitted data (e.g. re-transmitted data packet) in the receiver.

Therefore, the receiver decodes all received data packets for possible transmission errors and informs the transmitter about the decoding result. In an embodiment of the invention, this is carried out in that the receiver transmits a positive acknowledgment message (ACK) using the feedback channel for each received error-free data (e.g. error-free data packet) to the transmitter. In a corresponding manner, the receiver transmits a negative acknowledgment message (NACK) using the feedback channel for each received erroneous data (e.g. erroneous data packet) to the transmitter.

If the transmitter receives the message that particular data (e.g. a particular data packet) has been transmitted with errors, the HARQ method initiates a repetition of the transmission (also referred to as re-transmission) for the transmitted data, which have been transmitted with errors (e.g. transmitted data packet, which has been transmitted with errors). If the transmitter receives the message that particular data (e.g. a particular data packet) has been transmitted without any error, the HARQ method continues the transmission of new data (e.g. new data packets).

In an embodiment of the invention, corresponding memories (e.g. memory buffer) are provided in the transmitter and in the receiver for the HARQ method. A respective copy of each data to be transmitted (e.g. a respective copy of each data packet to be transmitted) is stored (e.g. buffered) in the memory of the transmitter as long as the data (e.g. the data packet) has successfully been transmitted or the attempt of a successful transmission has been given up after a maximum number of re-transmission has been reached. Then, the copy of the data (e.g. the copy of the data packet) is deleted from the memory again. Correspondingly, a respective copy of each received data (e.g. respective copy of each received data packet) is stored (e.g. buffered) in the memory of the receiver as long as the data (e.g. the data packet) has successfully been received or the attempt of a successful receipt has been given up after a particular time period.

Various HARQ methods may be used in different embodiments of the invention. In an embodiment of the invention, wherein UMTS Release 5 or 6 is used, an HARQ method is provided, which is based on the so called “N-Channel Stop-and-Wait” method. In accordance with the “N-Channel Stop-and-Wait” method, the transmission data (e.g. the transmission data packets) are physically transmitted via one single transmission channel. However, the one single transmission channel is divided in N sub-channels in time.

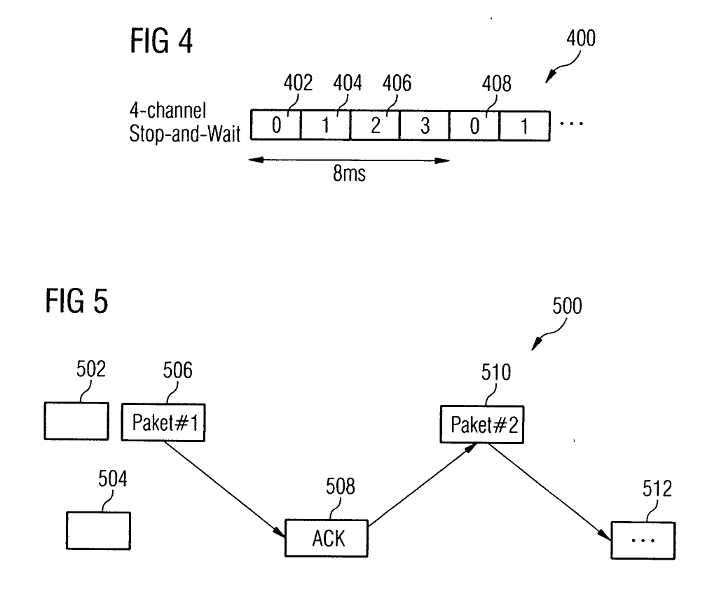

FIG. 4 shows four sub-channels 402, 404, 406, 408, of an “N-Channel Stop-and-Wait” method in accordance with an embodiment of the invention in a diagram 400. In an alternative embodiment of the invention, N can be an arbitrary number, e.g. N can be 1, 2, 3, 4, 5, 6, 7, 8, 9, 10, etc.

The four sub-channels 402, 404, 406, 408, are numbered from 0 to 3 in the diagram 400 in FIG. 4. In an embodiment of the invention, each of the four sub-channels 402, 404, 406, 408, has a length of 2 ms (although in alternative embodiments of the invention, the sub-channels 402, 404, 406, 408, may have different lengths). The Stop-and-Wait HARQ method is applied to each of the four sub-channels 402, 404, 406, 408, wherein the application of a HARQ method to a sub-channel is also referred to as HARQ process. In other words, in an embodiment of the invention, an HARQ process is provided for each sub-channel.

The basic operation of the Stop-and-Wait HARQ method for each sub-channel is shown in a diagram 500 in FIG. 5 and is as follows.

The transmitter 502 (e.g. the UE 118, in an alternative embodiment of the invention, e.g. the NodeB 108, 109, 110, 111) transmits first data (e.g. a first data packet #1 506) to the receiver 504 (e.g. the NodeB 108, 109, 110, 111, in an alternative embodiment of the invention, e.g. the UE 118) and waits for the corresponding transmission result, respectively. Dependent from the transmission result, the transmitter 502 transmits new data, e.g. second data (e.g. a second data packet #2 510) (in case that the transmitter 502 receives an ACK message 508 from the receiver 504 via the feedback channel), or a copy of the previously transmitted first data (e.g. a copy of the first data packet #1 506) (in case that the transmitter 502 receives a NACK message (not shown) from the receiver 504 via the feedback channel). This procedure is repeatedly continued as long as desired (in FIG. 5 symbolized by block 512).

During the time period, in which the transmitter 502 waits for the transmission result, no data (e.g. no data packets) are transmitted via the sub-channel. As a result, the transmission capacities of the respective sub-channel remain unused.

As already mentioned, in an embodiment of the invention, in which UMTS Release 5 is used, an asynchronous HARQ method is provided in the downlink. In the asynchronous HARQ method, the re-transmissions are independent from the transmission time instant of the initial data transmission (in an embodiment of the invention, independent from the HARQ process used for the initial data transmission).

In an embodiment of the invention, in which for example UMTS Release 6 or the UMTS LTE system is used, a synchronous HARQ method is provided in the uplink. In the synchronous HARQ method, the re-transmissions can only be sent dependent from the transmission time instant of the initial data transmission (in an embodiment of the invention, dependent from the HARQ process used for the initial data transmission). In an embodiment of the invention, the re-transmissions can only be sent in the same HARQ process that has been used for the initial data transmission.

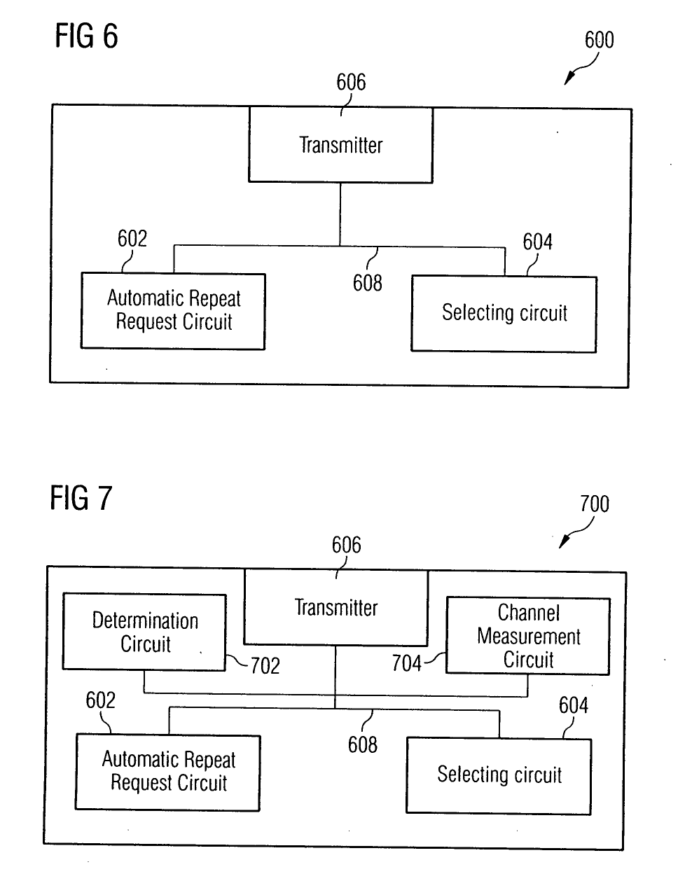

FIG. 6 shows a data transmission device 600 in accordance with an embodiment of the invention. In an embodiment of the invention, the data transmission device 600 is the subscriber terminal 118 (user equipment, UE) as described above with reference to FIG. 1.

The data transmission device 600 includes an automatic repeat request circuit 602 to provide a plurality of automatic repeat request processes. In an embodiment of the invention, the automatic repeat request circuit 602 implements a plurality of automatic repeat request processes such as those described above. In an embodiment of the invention, the automatic repeat request circuit 602 implements a plurality of hybrid automatic repeat request processes, e.g. a plurality of synchronous hybrid automatic repeat request processes or a plurality of asynchronous hybrid automatic repeat request processes.

Furthermore, the data transmission device 600 includes a selecting circuit 604 to select an automatic repeat request process from a plurality of automatic repeat request processes (e.g. provided by the automatic repeat request circuit 602), the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed. In an embodiment of the invention, the predetermined number of automatic repeat request data re-transmissions is a predetermined minimum number of automatic repeat request data re-transmissions. In another embodiment of the invention, the predetermined duration of an automatic repeat request transmission period is a predetermined minimum duration of an automatic repeat request transmission period.

In another embodiment of the invention, the selecting circuit 604 is configured to select the automatic repeat request process taking into account at least one transmission time gap, during which no data transmission or data re-transmission is possible.

Moreover, in an embodiment of the invention, the data transmission device 600 includes a transmitter 606 to transmit the data using the selected automatic repeat request process. In an embodiment of the invention, the transmitter 606 is a radio transmitter to transmit the data via a radio interface. In an embodiment of the invention, the transmitter 606 is configured to transmit the data using Frequency Division Multiple Access, e.g. Single Carrier Frequency Division Multiple Access. In another embodiment of the invention, the transmitter 606 is configured to transmit the data using Frequency Division Duplex.

The automatic repeat request circuit 602, the selecting circuit 604 and the transmitter 606 are coupled with each other (and with other common components of a transmission device such as a mobile radio device (e.g. mobile radio terminal device or mobile radio network device), which are not shown for reasons of simplicity but may be provided in an alternative embodiment of the invention) e.g. by means of a coupling 608 such as e.g. one or a plurality of busses.

The data transmission device 600 may be a terminal device, e.g. a mobile radio terminal device such as the subscriber terminal 118 (user equipment, UE) described above.

Thus, in an embodiment of the invention, the data transmission is an uplink data transmission from the terminal device to a network device.

In an alternative embodiment of the invention, the data transmission device 600 is a network device, e.g. a mobile radio network device such as e.g. as a mobile radio base station.

Thus, in an embodiment of the invention, the data transmission is a downlink data transmission from the network device to the terminal device.

The data transmission device 600 (e.g. the terminal device and/or the network device) may be configured in accordance with a Third Generation Partnership Project communication standard.

By way of example, the data transmission device 600 may be configured in accordance with a mobile radio communication system that is selected from a group of mobile radio communication systems consisting of:
a Global System for Mobile Communication (GSM) communication system;
a Universal Mobile Telecommunications System (UMTS) communication system;
a Universal Mobile Telecommunications System Long Term Evolution (UMTS LTE) communication system;
a Code Division Multiple Access (CDMA) communication system;
a Code Division Multiple Access 2000 (CDMA 2000) communication system;
a Freedom of Mobile Multimedia Access (FOMA) communication system.

However, any other mobile radio communication system may be implemented by the transmission device 600 in accordance with an alternative embodiment of the invention.

FIG. 7 shows a data transmission device 700 in accordance with another embodiment of the invention. The data transmission device 700 is similar to the data transmission device 600 shown in FIG. 6 and described above and includes some additional components which will be described in more detail below.

The data transmission device 700 may further include a determination circuit 702 to determine the predetermined number of automatic repeat request data re-transmissions and the predetermined duration of an automatic repeat request transmission period in accordance with at least one predetermined data transmission requirement. The at least one predetermined data transmission requirement may include the quality of service which should be provided for transmitting the data. In an alternative embodiment, the at least one predetermined data transmission requirement may include the guarantee of the synchronism of the hybrid automatic repeat request data transmission.

Furthermore, the data transmission device 700 may include a channel measurement circuit 704 to measure at least one channel during at least one transmission time gap. In another embodiment of the invention, the selecting circuit 604 is configured to select the automatic repeat request process taking into account the at least one transmission time gap, during which no data transmission or data re-transmission is possible. In an embodiment of the invention, the at least one transmission time gap may have a duration in the range of integer multiples of a time slot. Furthermore, in an embodiment of the invention, the at least one transmission time gap may have a duration in the range of about 2 ms to about 20 ms, e.g. a duration in the range of about 4 ms to about 10 ms.

In an embodiment of the invention, a process for e.g. a synchronous HARQ method is provided, in which in the case of transmission time gaps in the uplink transmission direction the selection for initial HARQ transmissions may be carried out depending on the quality of service and the guarantee of the synchronism of the data transmission.

In an embodiment of the invention, a process for e.g. a synchronous HARQ method is provided, in which in the case of transmission time gaps the selection of the transmission time instants for initial HARQ transmissions may be carried out by the terminal device such as the subscriber terminal 118 using the configuration from the network.

An embodiment of the invention includes the following features:
The following parameters are specified for each logical channel:
   A first parameter “minimum number of HARQ re-transmissions” is defined. The first parameter specifies the defined number of the HARQ re-transmissions, which are considered to be relevant for the transmission of the data of the logical channel.
   A second parameter “minimum duration of an automatic repeat request transmission period” is defined. The second parameter determines, together with the first parameter “minimum number of HARQ re-transmissions”, which transmission time instants for initial HARQ transmissions can be selected from the data transmission device (e.g. the subscriber terminal 118 such as the UE).
The configuration of the two parameters may be carried out by the network, e.g. the UMTS network, e.g. in dependency from the quality of service (QoS) and the guarantee of the synchronism of the HARQ data transmission. The configuration of the two parameters may be signalled to the UE by the network.

An effect of an embodiment of the invention may be seen in that the data transmission delay may be significantly reduced. Another effect of an embodiment of the invention may be seen in that the data transmission may be carried out in accordance with the configured quality of service.

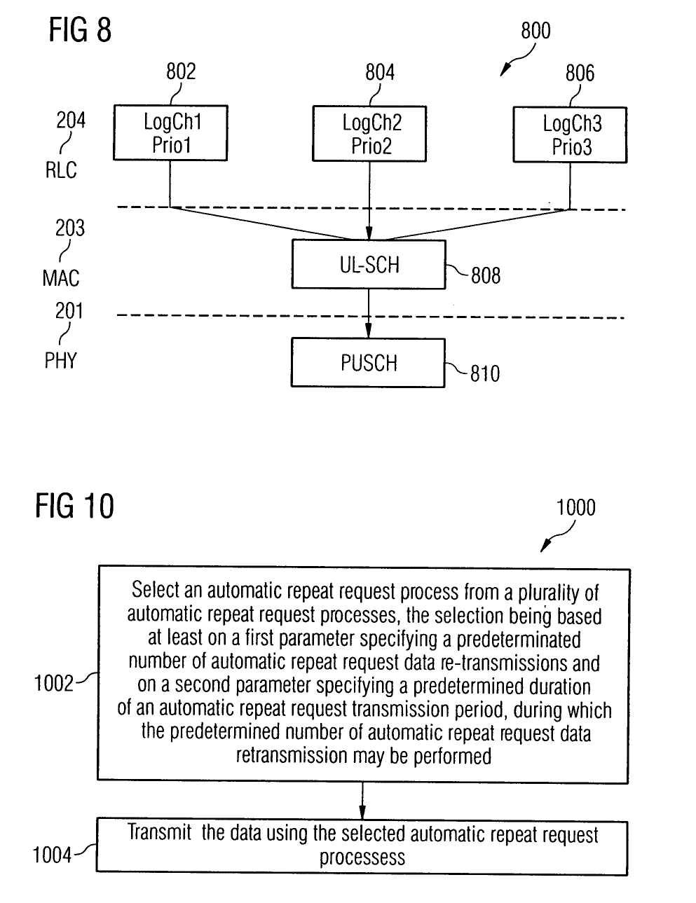

FIG. 8 shows an uplink data transmission scenario in accordance with an embodiment of the invention in a block diagram 800.

Without limiting the generality, the following configuration is considered in the following embodiments of the invention.
UMTS LTE communication system with the SC-FDMA multiple access method in the uplink direction;
FDD mode;
Duration of the transmission time gap: 8 ms;
Distance between the start of two succeeding transmission time gaps: 30 ms;
Number of the HARQ processes: 8;
Length of a radio frame: 10 ms;
Transmission Time Interval (TTI): 1 ms.

It should be mentioned that the concrete values are only examples and other values may be selected in alternative embodiments of the invention.

The uplink data transmission scenario as shown in FIG. 8 is considered, in which a subscriber or user uses three services in parallel, indicated by means of the logical channels LogCh1 802, LogCh2 804, LogCh3 806 on the Radio Link Control protocol layer (RLC protocol layer) 204.

In accordance with the quality of service (QoS) of the various services, different priorities (e.g. from priority “1” to priority “3”) are assigned to the logical channels LogCh1 802, LogCh2 804, LogCh3 806, wherein a priority “1” represents the highest priority and wherein a priority “3” represents the lowest priority. These priorities control the processing of the data provided on the logical channels LogCh1 802, LogCh2 804, LogCh3 806.

In general, the data of the logical channel having the highest priority (for example the first logical channel LogCh1 802) will be processed in a preferred manner. All three logical channels LogCh1 802, LogCh2 804, LogCh3 806, are multiplexed onto the same transport channel Uplink Shared Channel (UL-SCH) 808 on the Medium Access Control protocol Layer (MAC protocol layer) 203.

On the physical layer PHY 201, the transport channel UL-SCH 808 is mapped to the physical channel Physical Uplink Shared Channel (PUSCH) 810, on which the packet data are then transmitted to the base station NodeB (e.g. 108, 109, 110, 111) via the air interface 117.

In order to ensure the quality of service (QoS) and the synchronism of the HARQ data transmission in the case of transmission time gaps, the three logical channels LogCh1 802, LogCh2 804, LogCh3 806 are configured as follows. It should be mentioned that the concrete values are only examples and other values may be selected in alternative embodiments of the invention.
First logical channel LogCh1 802:
   “Minimum number of HARQ re-transmissions” R1=2;
   “Minimum duration of an automatic repeat request transmission period” Z1=30 ms;
Second logical channel LogCh2 804=Third logical channel LogCh3 806:
   “Minimum number of HARQ re-transmissions” R1=3;
   “Minimum duration of an automatic repeat request transmission period” Z2=40 ms.

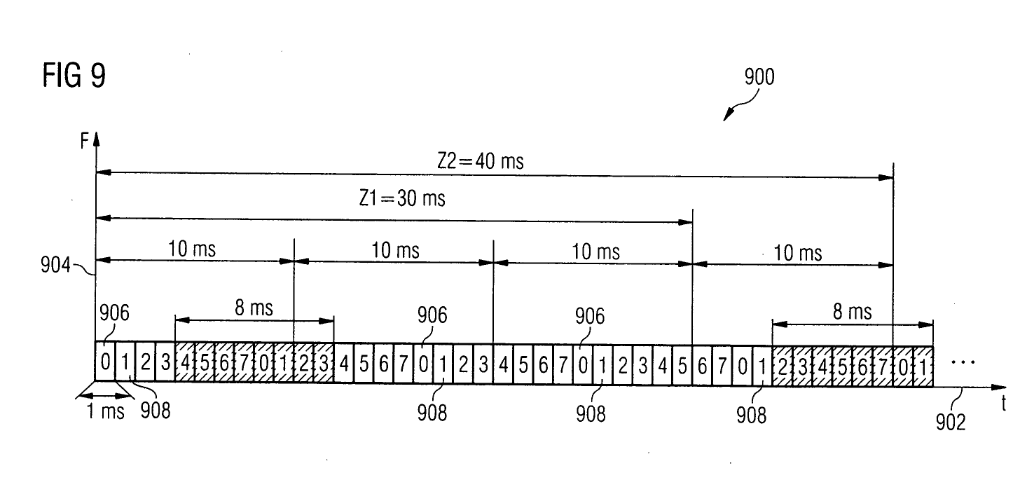

FIG. 9 shows a corresponding resulting uplink data transmission scheme 900 in accordance with an embodiment of the invention.

The uplink data transmission scheme 900 shown includes transmission time gaps and HARQ processes in accordance with an embodiment of the invention. The horizontal axis 902 represents the time t, whereas the vertical axis 904 represents the frequency band f. The assumed 8 HARQ processes (in general an arbitrary number of HARQ processes) are numbered with 0 to 7 and have a respective duration of 1 ms, although in other embodiments of the invention, other durations may be provided.

The HARQ processes that are affected by a transmission time gap of 8 ms are hatched in FIG. 9 and are not available for the data transmission.

In an embodiment of the invention, the case is considered, in which data from the first logical channel LogCh1 802 (having e.g. priority “1”) are present for the transmission. Due to the highest priority “1” of the data from the first logical channel LogCh1 802, the data transmission device (e.g. the UE 118) selects those transmission time instants for the initial HARQ-transmission, which ensure the transmission of the defined number of re-transmissions of R1=2 within the defined transmission window (e.g. represented by the duration of an automatic repeat request transmission period) of Z1=30 ms. In the embodiment shown in FIG. 9, only the HARQ processes #0, #1, #2, #3, #4, #5 may be used. The data transmission device (e.g. the UE 118) selects that process, which may be used at the earliest time instant, from the available subset of HARQ processes #0, #1, #2, #3, #4, #5. Thus, in this embodiment, the data transmission device (e.g. the UE 118) selects the HARQ process #0 (in FIG. 9 designated with reference number 906) for data transmission, e.g. for uplink data transmission.

In an embodiment of the invention, the case is considered, in which data from the second logical channel LogCh2 804 (having e.g. priority “2”) are present for the transmission. Due to the priority “2” of the data from the second logical channel LogCh2 804, the data transmission device (e.g. the UE 118) selects those transmission time instants for the initial HARQ transmission, which ensure the transmission of the defined number of re-transmissions of R1=3 within the defined transmission window (e.g. represented by the duration of an automatic repeat request transmission period) of Z1=40 ms. In the embodiment shown in FIG. 9, only the HARQ processes #0, #1 may be used. The data transmission device (e.g. the UE 118) selects that process, which may be used at the earliest time instant, from the available subset of HARQ processes #0, #1. Thus, in this embodiment, the data transmission device (e.g. the UE 118) selects e.g. the HARQ process #1 (in FIG. 9 designated with reference number 908) for data transmission, e.g. for uplink data transmission.

Now, the case is considered, in which data from all three logical channels LogCh1 802, LogCh2 804 and LogCh3 806 are present (e.g. queuing in wait queue buffers, wherein one wait queue buffer may be uniquely assigned to a respective HARQ process) for the transmission and which may be transmitted in the same (common) HARQ process due to the transmission capacity available on the transport channel UL-SCH 808. In this case, the selection of the transmission time instants for the initial HARQ transmission is carried out on the basis of the configuration of the highest prioritized logical channel, i.e. for example the first logical channel LogCh1 802, in one embodiment of the invention. Thus, only the HARQ processes #0, #1, #2, #3, #4, #5 may be used. The data transmission device (e.g. the UE 118) selects that process, which may be used at the earliest time instant, from the available subset of HARQ processes #0, #1, #2, #3, #4, #5. Thus, in this embodiment, the data transmission device (e.g. the UE 118) selects the HARQ process #0 (in FIG. 9 designated with reference number 906) for data transmission, e.g. for uplink data transmission.

In an embodiment of the invention, the case is considered, in which (similar as in the previously described embodiment) data of all three logical channels LogCh1 802, LogCh2 804 and LogCh3 806 are present for the transmission. However, in this embodiment of the invention, the data of the three logical channels LogCh1 802, LogCh2 804 and LogCh3 806 are separately transmitted in subsequent HARQ processes due to the limited transmission capacity available on the transport channel UL-SCH 808. Thus, in an embodiment of the invention, the HARQ processes #0, #1, #2, #3, #4, #5 may be used for the first logical channel LogCh1 802, whereas only the HARQ processes #0, #1 may be used for the second logical channel LogCh2 804 and the third logical channel LogCh3 806. In order to satisfy the transmission requirement of all three logical channels LogCh1 802, LogCh2 804 and LogCh3 806, the transmission device (e.g. the UE 118) may select the HARQ processes as follows
HARQ process #2 for the first logical channel LogCh1 802;
HARQ process #0 for the second logical channel LogCh2 804; and
HARQ process #1 for the third logical channel LogCh3 806.

In an embodiment of the invention, the network (e.g. the UMTS network) configures the following two parameters in the data transmission device (e.g. in the UE 118) dependent from the quality of service (QoS) and the guarantee of the synchronism of the HARQ data transmission in the uplink direction (e.g. for each logical channel):
A first parameter “minimum number of HARQ re-transmissions”.
A second parameter “minimum duration of an automatic repeat request transmission period”.

The parameters are signalled to the data transmission device (e.g. the UE 118) and serve to select only those transmission time instants (and thus only those HARQ processes, for example) for initial HARQ transmissions in the case of transmission time gaps, which ensure the transmission of the defined number of re-transmissions within the defined transmission time window.

FIG. 10 shows a flow diagram 1000 illustrating a method for transmitting data in accordance with an embodiment of the invention.

At 1002, an automatic repeat request process is selected from a plurality of automatic repeat request processes, the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed.

Furthermore, at 1004, the data are transmitted using the selected automatic repeat request process.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for transmitting data, the method comprising:
selecting an automatic repeat request process from a plurality of automatic repeat request processes, the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed; and
transmitting the data using the selected automatic repeat request process.

2. The method of claim 1, wherein the plurality of automatic repeat request processes are a plurality of hybrid automatic repeat request processes.

3. The method of claim 2, wherein the plurality of hybrid automatic repeat request processes are a plurality of synchronous hybrid automatic repeat request processes.

4. The method of claim 2, wherein the plurality of hybrid automatic repeat request processes are a plurality of asynchronous hybrid automatic repeat request processes.

5. The method of claim 1, wherein the predetermined number of automatic repeat request data re-transmissions is a predetermined minimum number of automatic repeat request data re-transmissions.

6. The method of claim 1, wherein the predetermined duration of an automatic repeat request transmission period is a predetermined minimum duration of an automatic repeat request transmission period.

7. The method of claim 2, wherein the predetermined number of automatic repeat request data re-transmissions and the predetermined duration of an automatic repeat request transmission period are determined in accordance with at least one predetermined data transmission requirement.

8. The method of claim 7, wherein the at least one predetermined data transmission requirement comprises a quality of service which should be provided for transmitting the data.

9. The method of claim 7, wherein the at least one predetermined data transmission requirement comprises a guarantee of synchronism of the hybrid automatic repeat request data transmission.

10. The method of claim 1, wherein the automatic repeat request process is selected taking into account at least one transmission time gap, during which no data transmission or data re-transmission is possible.

11. The method of claim 10, wherein the at least one transmission time gap is at least one transmission time gap used for measuring at least one channel.

12. The method of claim 10, wherein the at least one transmission time gap has a duration in a range of integer multiples of a time slot.

13. The method of claim 11, wherein the at least one transmission time gap has a duration in a range of integer multiples of a time slot.

14. The method of claim 1, wherein the data are transmitted via a radio interface.

15. The method of claim 1, wherein the data are transmitted from a terminal device to a network device.

16. The method of claim 1, wherein the data are transmitted from a network device to a terminal device.

17. The method of claim 1, wherein the data are transmitted using Frequency Division Multiple Access.

18. The method of claim 17, wherein the data are transmitted using Single Carrier Frequency Division Multiple Access.

19. The method of claim 1, wherein the data are transmitted using Frequency Division Duplex.

20. The method of claim 1, used in a mobile radio communication system.

21. The method of claim 20, used in a mobile radio communication system in accordance with a Third Generation Partnership Project communication standard.

22. The method of claim 1, used in a mobile radio communication system that is selected from a group of mobile radio communication systems consisting of:
a Global System for Mobile Communication communication system;
a Universal Mobile Telecommunications System communication system;
a Universal Mobile Telecommunications System Long Term Evolution communication system;
a Code Division Multiple Access communication system;
a Code Division Multiple Access 2000 communication system; and
a Freedom of Mobile Multimedia Access communication system.

23. A data transmission device, comprising:
an automatic repeat request circuit configured to provide a plurality of automatic repeat request processes;
a selecting circuit configured to select an automatic repeat request process from a plurality of automatic repeat request processes, the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed; and
a transmitter configured to transmit the data using the selected automatic repeat request process.

24. The data transmission device of claim 23, wherein the plurality of automatic repeat request processes are a plurality of hybrid automatic repeat request processes.

25. The data transmission device of claim 24, wherein the plurality of hybrid automatic repeat request processes are a plurality of synchronous hybrid automatic repeat request processes.

26. The data transmission device of claim 24, wherein the plurality of hybrid automatic repeat request processes are a plurality of asynchronous hybrid automatic repeat request processes.

27. The data transmission device of claim 23, wherein the predetermined number of automatic repeat request data re-transmissions is a predetermined minimum number of automatic repeat request data re-transmissions.

28. The data transmission device of claim 23, wherein the predetermined duration of an automatic repeat request transmission period is a predetermined minimum duration of an automatic repeat request transmission period.

29. The data transmission device of claim 24, further comprising a determination circuit configured to determine the predetermined number of automatic repeat request data re-transmissions and the predetermined duration of an automatic repeat request transmission period in accordance with at least one predetermined data transmission requirement.

30. The data transmission device of claim 29, wherein the at least one predetermined data transmission requirement comprises a quality of service which should be provided for transmitting the data.

31. The data transmission device of claim 29, wherein the at least one predetermined data transmission requirement comprises a guarantee of synchronism of the hybrid automatic repeat request data transmission.

32. The data transmission device of claim 23, wherein the selecting circuit is configured to select the automatic repeat request process taking into account at least one transmission time gap, during which no data transmission or data re-transmission is possible.

33. The data transmission device of claim 32, further comprising a channel measurement circuit configured to measure at least one channel during the at least one transmission time gap.

34. The data transmission device of claim 32, wherein the at least one transmission time gap has a duration in a range of integer multiples of a time slot.

35. The data transmission device of claim 34, wherein the at least one transmission time gap has a duration in a range of integer multiples of a time slot.

36. The data transmission device of claim 23, wherein the transmitter is a radio transmitter to transmit the data via a radio interface.

37. The data transmission device of claim 23, wherein the transmitter is configured to transmit the data using Frequency Division Multiple Access.

38. The data transmission device of claim 37, wherein the transmitter is configured to transmit the data using Single Carrier Frequency Division Multiple Access.

39. The data transmission device of claim 23, wherein the transmitter is configured to transmit the data using Frequency Division Duplex.

40. The data transmission device of claim 23, being configured as a terminal device.

41. The data transmission device of claim 40, being configured as a mobile radio terminal device.

42. The data transmission device of claim 23, being configured as a network device.

43. The data transmission device of claim 42, being configured as a mobile radio network device.

44. The data transmission device of claim 43, being configured as a mobile radio base station.

45. The data transmission device of claim 23, being configured in accordance with a Third Generation Partnership Project communication standard.

46. The data transmission device of claim 23, being configured in accordance with a mobile radio communication system that is selected from a group of mobile radio communication systems consisting of:
a Global System for Mobile Communication communication system;
a Universal Mobile Telecommunications System communication system;
a Universal Mobile Telecommunications System Long Term Evolution communication system;
a Code Division Multiple Access communication system;
a Code Division Multiple Access 2000 communication system; and
a Freedom of Mobile Multimedia Access communication system.

47. A computer program product resident on a computer-readable medium, the computer program product comprising:
computer instruction code to select an automatic repeat request process from a plurality of automatic repeat request processes, the selection being based at least on a first parameter specifying a predetermined number of automatic repeat request data re-transmissions and on a second parameter specifying a predetermined duration of an automatic repeat request transmission period, during which the predetermined number of automatic repeat request data re-transmissions may be performed; and
computer instruction code to transmit data using the selected automatic repeat request process.
